(19) United States
(12) Patent Application Publication
(10) Pub. No.: US 2024/0100865 A1
(43) Pub. Date: Mar. 28, 2024

(54) MEDIUM MENDING DEVICE AND IMAGE FORMING APPARATUS

(71) Applicant: FUJIFILM Business Innovation Corp., Tokyo (JP)

(72) Inventor: Makio UEHARA, Kanagawa (JP)

(73) Assignee: FUJIFILM Business Innovation Corp., Tokyo (JP)

(21) Appl. No.: 18/188,454

(22) Filed: Mar. 23, 2023

(30) Foreign Application Priority Data
Sep. 27, 2022 (JP) 2022-154032

(51) Int. Cl. B41J 11/00; B41J 29/377; G03G 15/20; G03G 21/20

(52) U.S. Cl. CPC B41J 11/0024; B41J 29/377; G03G 15/2053; G03G 21/206

(57) ABSTRACT

A medium mending device includes a heating component configured to heat a medium having an image recorded, and a pressing component positioned against the heating component and configured to press the medium that is to be nipped between the pressing component and the heating component, the pressing component pressing the medium with such a pressure as to squash any flaws in the medium.

### CROSS-REFERENCE TO RELATED APPLICATIONS

This application is based on and claims priority under 35 USC 119 from Japanese Patent Application No. 2022-154032 filed Sep. 27, 2022.

### BACKGROUND

### (i) Technical Field

The present disclosure relates to a medium mending device and an image forming apparatus.

### (ii) Related Art

A known technique disclosed by Japanese Unexamined Patent Application Publication No. 2020-52142 ([0074] to [0114], FIG. 2) relates to a fixing device included in an image forming apparatus and configured to fix unfixed developer transferred to a medium.

According to Japanese Unexamined Patent Application Publication No. 2020-52142, the fixing device (50) includes the following: a first fixing unit provided on the upstream side and including a pressing roll (61) and a heating belt (62); a second fixing unit provided on the downstream side and including a pressing roll (34) and a heating roll (32); and a cooling device (90) provided on the downstream side relative to the pressing roll (34) and configured to cool the medium. In the above configuration, the first fixing unit and the second fixing unit fix a toner image by applying heat and pressure to the toner image, and the cooling device (90) cools the toner image.

### SUMMARY

Aspects of non-limiting embodiments of the present disclosure relate to mending any flaws in a medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a medium mending device including a heating component configured to heat a medium having an image recorded, and a pressing component positioned against the heating component and configured to press the medium that is to be nipped between the pressing component and the heating component, the pressing component pressing the medium with such a pressure as to squash any flaws in the medium.

### BRIEF DESCRIPTION OF THE DRAWINGS

An exemplary embodiment of the present disclosure will be described in detail based on the following figures, wherein:

FIG. 1 illustrates the entirety of an image forming apparatus according to an exemplary embodiment of the present disclosure; and

FIG. 2 illustrates relevant elements of a fixing device, a medium mending device, and an output roller according to the exemplary embodiment.

### DETAILED DESCRIPTION

An exemplary embodiment of the present disclosure will now be described with reference to the accompanying drawings. Note that the present disclosure is not limited to the following exemplary embodiment.

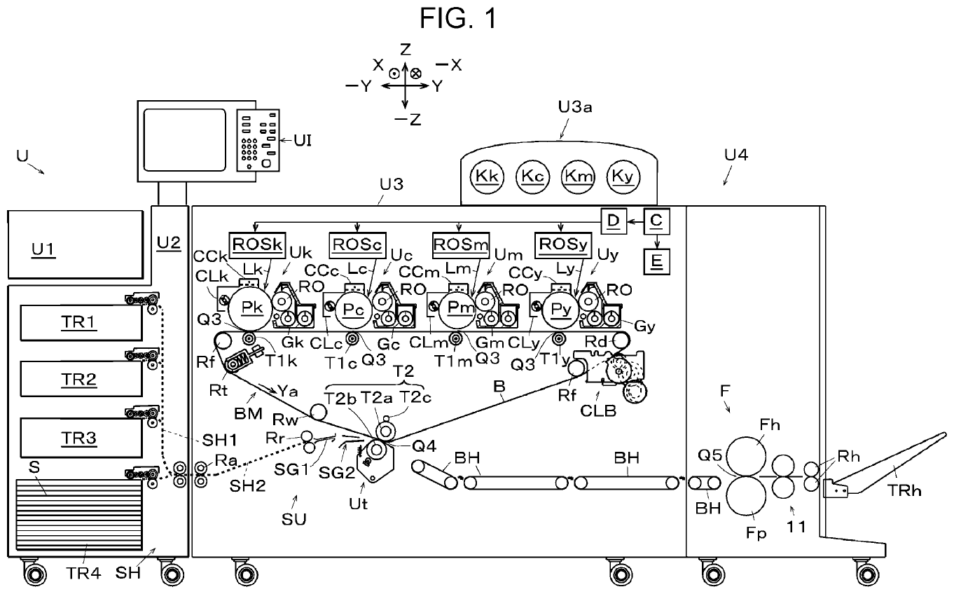

To help understand the following description, FIG. 1 is provided with an X axis representing the front-rear direction; a Y axis representing the left-right direction; a Z axis representing the top-bottom direction; and arrows X, −X, Y, −Y, Z, and −Z representing the frontward, rearward, rightward, leftward, upward, and downward directions or the front, rear, right, left, upper, and lower sides, respectively.

Furthermore, in FIG. 1, a circle with a dot is regarded as an arrow representing the direction from the back of the page toward the front of the page, and a circle with a cross is regarded as an arrow representing the direction from the front of the page toward the back of the page.

To help understand the following description, irrelevant elements are not illustrated in the drawings.

### Exemplary Embodiment

FIG. 1 illustrates the entirety of an image forming apparatus according to an exemplary embodiment of the present disclosure.

Referring to FIG. 1, a copying machine U is an exemplary image forming apparatus and includes an operation unit UI; a scanner device U1, which is an exemplary image reading component; a sheet feeding device U2; a printer unit U3, which is an exemplary image recording component; and a sheet output unit U4.

The operation unit UI includes input parts, for example, a power button and various keys such as a copy start key, a copy-number-setting key, and a numerical keypad; and other parts such as a display.

The scanner device U1 reads a document (not illustrated), converts an image of the document into image information, and inputs the image information to the printer unit U3.

The sheet feeding device U2 includes a plurality of sheet feeding trays TR1, TR2, TR3, and TR4, which are exemplary sheet feeding units. The sheet feeding trays TR1 to TR4 each contain recording sheets S, which are each an exemplary medium. A sheet feeding path SH1 is an exemplary transport path for the medium and extends from the sheet feeding trays TR1 to TR4 to the printer unit U3.

The printer unit U3 illustrated in FIG. 1 includes a controller C and a power circuit E, which is controlled by the controller C and supplies power to relevant elements of the printer unit U3. The controller C receives the image information representing the document that is read by the scanner device U1, or image information that is transmitted from a personal computer serving as an exemplary information transmitting device (not illustrated) connected to the copying machine U.

The controller C processes the received image information into pieces of printing information for yellow Y, magenta M, cyan C, and black K and outputs the pieces of printing information to a laser driving circuit D, which is an exemplary driving circuit for latent-image-forming components. The laser driving circuit D receives a laser driving signal from the controller C and outputs with a predetermined timing the laser driving signal to exposure devices ROSy, ROSm, ROSc, and ROSk, which are the exemplary latent-image-forming components for the respective colors.

Image carrier units Uy, Um, Uc, and Uk for the respective colors of Y, M, C, and K are provided below the respective exposure devices ROSy, ROSm, ROSc, and ROSk.

Referring to FIG. 1, the image carrier unit Uk for black K includes a photoconductor drum Pk, which is an exemplary image carrying component; a charging corotron CCk, which is an exemplary charging component; and a photoconductor cleaner CLk, which is an exemplary cleaning component for the image carrying component. The image carrier units Uy, Um, and Uc for the other colors of Y, M, and C also include respective photoconductor drums Py, Pm, and Pc; respective charging corotrons CCy, CCm, and CCc; and respective photoconductor cleaners CLy, CLm, and CLc.

In the present exemplary embodiment, the photoconductor drum Pk for the color K, which tends to be used frequently and therefore wears fast, has a larger diameter than the photoconductor drums Py, Pm, and Pc for the other colors. Correspondingly, the photoconductor drum Pk is rotatable faster and is given a longer life than the others.

The photoconductor drums Py, Pm, Pc, and Pk are uniformly charged by the respective charging corotrons CCy, CCm, CCc, and CCk and are then irradiated with respective laser beams Ly, Lm, Lc, and Lk, which are exemplary latent-image-forming rays, emitted from the respective exposure devices ROSy, ROSm, ROSc, and ROSk, whereby electrostatic latent images are formed on the respective photoconductor drums Py, Pm, Pc, and Pk. The electrostatic latent images thus formed on the photoconductor drums Py, Pm, Pc, and Pk are developed into toner images in the respective colors of yellow Y, magenta M, cyan C, and black K by developing rolls RO, which are exemplary developing members, included in respective developing devices Gy, Gm, Gc, and Gk, which are exemplary developing components.

The toner images on the photoconductor drums Py, Pm, Pc, and Pk are sequentially transferred to an intermediate transfer belt B, which is an exemplary intermediate transfer component and an exemplary image carrying component, in respective first transfer areas Q3 by respective first transfer rolls T1y, T1m, T1c, and T1k, which are exemplary first transfer components, whereby the toner images are superposed one on top of another and form a multicolor image, or a so-called color image, on the intermediate transfer belt B. The color image thus formed on the intermediate transfer belt B is transported to a second transfer area Q4.

If the image information contains black image data alone, only the photoconductor drum Pk and the developing device Gk for black K are used, whereby only a black toner image is formed.

After the above first transfer process, residual toner particles on the photoconductor drums Py, Pm, Pc, and Pk are removed by the respective photoconductor cleaners CLy, CLm, CLc, and CLk.

Combinations of the image carrier units Uy, Um, Uc, and Uk and the respective developing devices Gy, Gm, Gc, and Gk are regarded as toner-image-forming units Uy+Gy, Um+Gm, Uc+Gc, and Uk+Gk and serve as exemplary image forming components.

The printer unit U3 is provided at the top thereof with a toner dispenser U3a, which is an exemplary refilling component. Toner cartridges Ky, Km, Kc, and Kk are exemplary developer containing components and are detachably attached to the toner dispenser U3a. When toners in the respective developing devices Gy, Gm, Gc, and Gk are consumed with an image forming operation, fresh toners in the respective toner cartridges Ky, Km, Kc, and Kk are supplied to the respective developing devices Gy, Gm, Gc, and Gk.

The intermediate transfer belt B is located below the photoconductor drums Py, Pm, Pc, and Pk and is stretched over the following: an intermediate driving roll Rd, which is an exemplary driving component for the intermediate transfer component; an intermediate tension roll Rt, which is an exemplary tension applying component that applies a tension to the intermediate transfer belt B; an intermediate steering roll Rw, which is an exemplary first skew correcting component that corrects any skew or meander of the intermediate transfer belt B; a plurality of intermediate idler rolls Rf, which are exemplary follower components; and a backup roll T2a, which is an exemplary counter component provided in the second transfer area Q4. The intermediate transfer belt B thus supported is rotatable in the direction of arrow Ya with the activation of the intermediate driving roll Rd.

A combination of the intermediate driving roll Rd, the intermediate tension roll Rt, the intermediate steering roll Rw, the intermediate idler rolls Rf, the backup roll T2a, the first transfer rolls T1y, T1m, T1c, and T1k, the intermediate transfer belt B, and other relevant elements is regarded as a belt module BM, which is an exemplary intermediate transfer device. The belt module BM according to the present exemplary embodiment is an exchangeable unit that is detachable from the printer unit U3.

A second transfer unit Ut is an exemplary transfer-transporting component and is provided below the backup roll T2a. The second transfer unit Ut includes a second transfer roll T2b, which is an exemplary transfer member. The second transfer roll T2b is positioned against the backup roll T2a. The area where the second transfer roll T2b faces the intermediate transfer belt B is regarded as the second transfer area Q4. The backup roll T2a is provided with a contact roll T2c, which is an exemplary contact component for voltage application and is in contact with the backup roll T2a. The contact roll T2c receives a second transfer voltage, which is applied with a preset timing from the power circuit E controlled by the controller C and has the same polarity as for toner charging.

A combination of the rolls T2a to T2c is regarded as a second transfer device T2, which is as an exemplary second transfer component. A combination of the intermediate transfer belt B, the first transfer rolls T1y, T1m, T1c, and T1k, the second transfer device T2, and other relevant elements is regarded as a transfer device B+T1+T2, which is an exemplary transfer component.

A sheet transport path SH2 runs below the belt module BM. A recording sheet S fed from the sheet feeding path SH1 in the sheet feeding device U2 is transported to the sheet transport path SH2 by transporting rolls Ra, which are exemplary transporting components. Synchronously with the timing of any toner image's being transported to the second transfer area Q4, the recording sheet S in the sheet transport path SH2 is forwarded by a registration roll Rr, which is an exemplary forwarding component, and is guided to the second transfer area Q4 by sheet guides SG1 and SG2, which are exemplary medium guiding components.

The toner image on the intermediate transfer belt B is transferred to the recording sheet S by the second transfer device T2 when passing through the second transfer area Q4. In the case of a color image, toner images superposed one on top of another on the intermediate transfer belt B in the first transfer process are transferred to the recording sheet S at a time in a second transfer process.

The intermediate transfer belt B having undergone the second transfer process is cleaned by a belt cleaner CLB, which is an exemplary cleaning component for the intermediate transfer component.

The recording sheet S having received the toner image in the second transfer process is transported to medium transporting belts BH, which are exemplary transporting components. The medium transporting belts BH transport the recording sheet S to a fixing device F. The fixing device F is an exemplary fixing component and includes a heating roller Fh, which is an exemplary heating component for fixing; and a pressing roller Fp, which is an exemplary pressing component for fixing. The heating roller Fh and the pressing roller Fp are positioned against each other, whereby a fixing area Q5 is defined.

The toner image on the recording sheet S is thermally fixed by the fixing device F when passing through the fixing area Q5. The recording sheet S having the toner image thus fixed by the fixing device F is outputted to an output tray TRh, which is an exemplary output part, by an output roller Rh, which is an exemplary medium transporting component.

A combination of the sheet feeding path SH1, the sheet transport path SH2, and other relevant paths is regarded as a sheet transport path SH. A combination of the sheet transport path SH, the transporting rolls Ra, the registration roll Rr, the sheet guides SG1 and SG2, the medium transporting belts BH, and other relevant elements is regarded as a sheet transporting device SU.

A combination of the toner-image-forming units Uy+Gy, Um+Gm, Uc+Gc, and Uk+Gk, the transfer device B+T1+T2, the fixing device F, the sheet transporting device SU, and other relevant elements is regarded as an image recording component configured to record an image on a recording sheet S.

### Description of Fixing Device, Medium Mending Device, and Output Roller

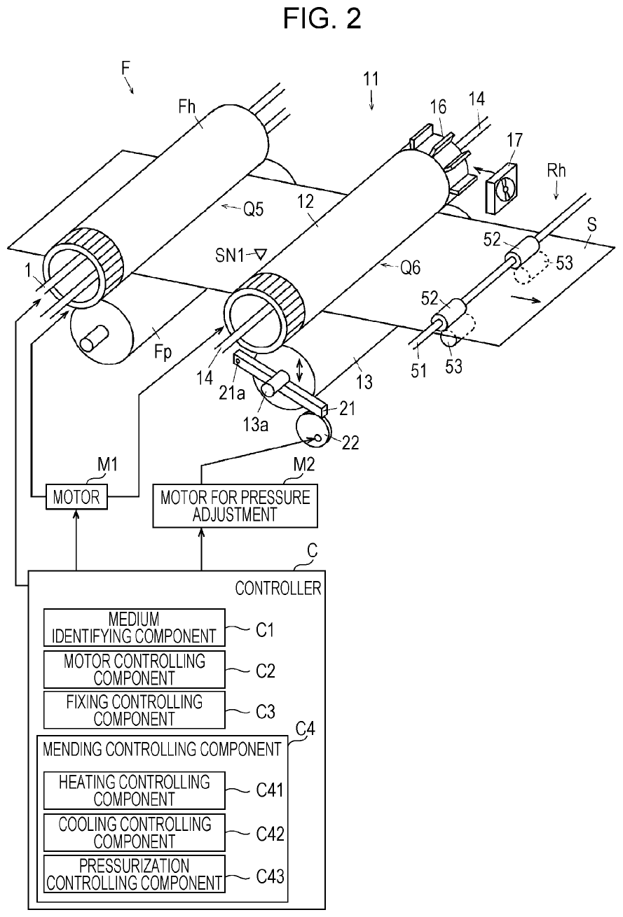

FIG. 2 illustrates relevant elements of the fixing device F, a medium mending device 11, and the output roller Rh according to the present exemplary embodiment.

Referring to FIGS. 1 and 2, the heating roller Fh and the pressing roller Fp of the fixing device F according to the present exemplary embodiment each have a length in the medium-width direction, or the axial direction, greater than the width of the largest one of recording sheets S handleable. The heating roller Fh according to the present exemplary embodiment is provided with a heater 1, which is an exemplary heat source and extends through the heating roller Fh. The heater 1 is controlled to be turned on and off, whereby the fixing temperature of the fixing area Q5 is controlled to a predetermined temperature that melts the developer.

The medium mending device 11 is located on the downstream side relative to the fixing device F in the direction of transport of the recording sheet S. The medium mending device 11 according to the present exemplary embodiment includes a thermopressing roller 12, which is an exemplary heating component for flaw mending; and a pressurizing roller 13, which is an exemplary pressing component for flaw mending. In the present exemplary embodiment, the thermopressing roller 12 is at the upper position to face a side (image recording side) of the recording sheet S on which the recorded image is present, and the pressurizing roller 13 is at the lower position to face the side of the recording sheet S that is opposite the image recording side.

As with the heating roller Fh and the pressing roller Fp, the thermopressing roller 12 and the pressurizing roller 13 according to the present exemplary embodiment each have a length in the medium-width direction, or the axial direction, greater than the width of the largest one of recording sheets S handleable. In the present exemplary embodiment, a driving force is transmitted to the thermopressing roller 12 from a motor (not illustrated) serving as an exemplary drive source.

The thermopressing roller 12 has a hollow cylindrical shape. The thermopressing roller 12 is provided with a flaw mending heater 14, which is an exemplary heat source and extends through the thermopressing roller 12.

The thermopressing roller 12 is provided with a heat sink 16, which is an exemplary heat radiating component and is supported at an axial end of the thermopressing roller 12. A fan 17 is an exemplary air sending component and is provided facing the heat sink 16. Thus, the fan 17 when activated sends cooling air to the heat sink 16. A combination of the heat sink 16 and the fan 17 is regarded as a cooling device 16+17, which is an exemplary cooling component.

A temperature sensor SN1 is an exemplary temperature detector and is provided facing the outer peripheral surface of the thermopressing roller 12. The temperature sensor SN1 is configured to detect the surface temperature of the thermopressing roller 12.

The pressurizing roller 13 according to the present exemplary embodiment is supported at a rotation shaft 13a by a lever 21, which is an exemplary movable component. The lever 21 is rotatable about a rotation center 21a. With the rotation of the lever 21, the pressurizing roller 13 moves toward and away from the thermopressing roller 12, whereby the contact pressure generated between the pressurizing roller 13 and the thermopressing roller 12 is changeable.

An eccentric cam 22 is an exemplary actuating component and is provided in contact with the tip of the lever 21. The eccentric cam 22 receives a driving force from a motor M2, which is an exemplary drive source for pressure adjustment. When the eccentric cam 22 rotates with the rotation of the motor M2, the lever 21 rotates, whereby the contact pressure between the pressurizing roller 13 and the thermopressing roller 12 is adjusted.

The thermopressing roller 12 according to the present exemplary embodiment may be made of a material having a higher thermal conductivity than the material for the pressurizing roller 13. Examples of the material having high thermal conductivity include metals such as copper, aluminum, brass, and stainless steel.

The pressurizing roller 13 according to the present exemplary embodiment may have a surface made of a material having a higher elasticity than the surface of the thermopressing roller 12. The pressurizing roller 13 may be made of, for example, rubber or the like so as to be capable of applying a pressure over the entire area of the recording sheet S in the width direction and also to be capable of squashing any flaws in the surface of the recording sheet S.

The thermopressing roller 12 and the pressurizing roller 13 according to the present exemplary embodiment may each have a treated surface, such as a surface coated with highly releasable fluorocarbon resin; a surface plated with a material having a low friction coefficient; or a specular surface, so that the sticking of the recording sheet S or the adhesion of developer to the surfaces of the rollers 12 and 13 is suppressed.

The output roller Rh is located on the downstream side relative to the medium mending device 11 in the direction of transport of the recording sheet S. The output roller Rh includes a rotation shaft 51, which extends in the medium-width direction; a plurality of driving rolls 52, which are supported by the rotation shaft 51 and are arranged at intervals; and follower rolls 53, which are positioned against the respective driving rolls 52. The rotation shaft 51 receives a driving force from a motor (not illustrated) serving as an exemplary drive source, whereby the recording sheet S is transported.

### Description of Controller According to Exemplary Embodiment

Referring to FIG. 2, the controller C is an exemplary controlling component included in the copying machine U and includes an input/output interface through which signals and so forth are to be transmitted to and from external devices. The controller C further includes a read-only memory (ROM) that stores programs, information, and the like to be used in executing relevant processes. The controller C further includes a random access memory (RAM) that temporarily stores relevant data. The controller C further includes a central processing unit (CPU) configured to execute processes corresponding to the programs stored in the ROM and the like. Thus, the controller C according to the present exemplary embodiment forms a small information processing device: a so-called microcomputer. Accordingly, the controller C is capable of realizing various functions by executing the programs stored in the ROM and the like.

The controller C according to the present exemplary embodiment receives signals from signal outputting elements and outputs signals to elements to be controlled.

### Description of Signal Outputting Elements

The controller C receives signals from signal outputting elements (not illustrated) such as sensors and so forth, including the temperature sensor SN1.

### Description of Elements to be Controlled

The controller C outputs signals to elements to be controlled, including the following: the power circuit E; a motor M1, which is configured to drive the fixing device F, the medium mending device 11, and the output roller Rh; and the motor M2 for pressure adjustment that is configured to drive the heater 1, the flaw mending heater 14, the fan 17, and the eccentric cam 22.

### Functions of Controller C

The controller C according to the present exemplary embodiment includes the following functional components (functional modules and program modules) C1 to C4.

A medium identifying component C1 is configured to identify whether the recording sheet S that is being used in the image forming operation is any of predetermined mending-object media. In the present exemplary embodiment, the predetermined mending-object media are coated paper, metallic paper, and transparent film, for example. Coated paper is a medium formed of, for example, paper coated with resin such as polytetrafluoroethylene (PET). Metallic paper is a medium formed of, for example, paper on which metallic foil such as aluminum foil and a transparent resin coating (urethane film or the like) are stacked. Transparent film is a film-type medium formed of, for example, transparent resin such as PET that is handleable on an overhead projector (OHP) or the like. Such media are characterized in having a surface that is softer than a metal material forming the walls of the transport paths along which the recording sheet S is guided and are therefore more likely to have flaws than plain paper or the like. Such flaws tend to be noticeable because of the smoothness or gloss of the surface of the media.

A motor controlling component C2 is configured to control the motor M1 and thus controls the rotation of the fixing device F, the medium mending device 11, and the output roller Rh. When the image forming operation is started, the motor controlling component C2 according to the present exemplary embodiment causes the heating roller Fh, the thermopressing roller 12, and the rotation shaft 51 to rotate. When the image forming operation ends, the motor controlling component C2 stops the rotation of the heating roller Fh, the thermopressing roller 12, and the rotation shaft 51. If the recording sheet S is any of the mending-object media, the motor controlling component C2 according to the present exemplary embodiment reduces the speed of transport of the recording sheet S by the fixing device F and the other relevant elements to be lower than the speed of transport of any medium other than the mending-object media (than in the case of plain paper or the like).

A fixing controlling component C3 is configured to control the fixing temperature for the fixing device F. The fixing controlling component C3 according to the present exemplary embodiment controls the heater 1 to be turned on/off, thereby controlling the fixing temperature to a predetermined temperature that melts the developer. In the present exemplary embodiment, the fixing temperature is set to about 200° C., for example.

A mending controlling component C4 includes a heating controlling component C41, a cooling controlling component C42, and a pressurization controlling component C43, which is an exemplary pressure adjusting component. The mending controlling component C4 is configured to control the operation of the medium mending device 11.

The heating controlling component C41 is configured to control the flaw mending heater 14 to be turned on/off, thereby controlling the temperature of a contact area Q6, which is defined between the thermopressing roller 12 and the pressurizing roller 13. The heating controlling component C41 according to the present exemplary embodiment refers to the result of temperature detection by the temperature sensor SN1 when controlling the on/off state of the flaw mending heater 14, thereby controlling the temperature of the contact area Q6 to a predetermined temperature. In the present exemplary embodiment, the predetermined temperature of the contact area Q6 to be targeted by the heating controlling component C41 is well below the melting point of the developer and is about 70° C., for example.

If the recording sheet S is any of the mending-object media, the heating controlling component C41 according to the present exemplary embodiment turns on the flaw mending heater 14 to heat the thermopressing roller 12, whereby the recording sheet S is heated. If the recording sheet S is none of the mending-object media, the heating controlling component C41 according to the present exemplary embodiment refrains from turning on the flaw mending heater 14; that is, the thermopressing roller 12 is not heated, and the recording sheet S is therefore not heated. Thus, the mending-object media are to be heated at a higher temperature than for any medium other than the mending-object media.

The cooling controlling component C42 is configured to control the fan 17 to cool the thermopressing roller 12. If the recording sheet S is any of the mending-object media, the cooling controlling component C42 according to the present exemplary embodiment stops the fan 17; that is, the thermopressing roller 12 is not cooled. If the recording sheet S is none of the mending-object media, the cooling controlling component C42 according to the present exemplary embodiment activates the fan 17 to cool the thermopressing roller 12, whereby the recording sheet S heated by passing through the fixing device F is cooled.

The pressurization controlling component C43 is configured to control the motor M2 for pressure adjustment to control where to stop the eccentric cam 22, thereby adjusting the contact pressure to be applied from the pressurizing roller 13. If the recording sheet S is any of the mending-object media, the pressurization controlling component C43 according to the present exemplary embodiment controls the contact pressure to such a level as to squash any flaws in the recording sheet S that is any of the predetermined media. In the present exemplary embodiment, the contact pressure for the mending-object media is set higher than for any medium other than the mending-object media. In the present exemplary embodiment, if the recording sheet S is none of the mending-object media, the contact pressure is adjusted to the lowest level required for the transport of the recording sheet S; that is, such a level as not to allow the recording sheet S to slip through the nip between the thermopressing roller 12 and the pressurizing roller 13.

In the present exemplary embodiment, if the recording sheet S is any of the mending-object media and is thick, the contact pressure is adjusted to a lower level than for thin media. While the reference for the adjustment of the contact pressure is the thickness of the recording sheet S in the above case, the reference is not limited thereto. For example, the reference for the adjustment of the contact pressure may be the material forming the surface of the recording sheet S. In other words, the contact pressure for a medium having a surface that is more likely to have flaws and is therefore more necessary to be mended may be set to a higher level, whereas the contact pressure for a medium having a surface that is less necessary to be mended may be set to a lower level.

### Functions of Exemplary Embodiment

In the copying machine U according to the present exemplary embodiment employing the above configuration, when an image forming operation is started, an image is transferred to a recording sheet S and is fixed by the fixing device F. If the recording sheet S is any of the mending-object media, the flaw mending heater 14 of the medium mending device 11 is activated to heat the thermopressing roller 12, and the recording sheet S is transported to the contact area Q6 where the contact pressure from the pressurizing roller 13 is set high. A mending-object medium may have scratches in the surface thereof before reaching the medium mending device 11. In the present exemplary embodiment, the recording sheet S is pressurized by the pressurizing roller 13 in the contact area Q6, whereby such scratches in the surface are squashed and flattened; that is, any flaws are mended.

In the present exemplary embodiment, the thermopressing roller 12 and the pressurizing roller 13 each extend over the entirety of the recording sheet S in the medium-width direction, so that the entirety of the surface of the recording sheet S in the medium width direction is to be mended.

In the present exemplary embodiment, the thermopressing roller 12 is heated when any mending-object medium passes through the contact area Q6. Therefore, in the present exemplary embodiment, the material forming the surface of the mending-object medium is more likely to deform with the heat.

Furthermore, in the present exemplary embodiment, the thermopressing roller 12 is positioned facing the image recording side of the medium.

In the present exemplary embodiment, the temperature of the contact area Q6 is set lower than the temperature of the fixing area Q5 and is well below the melting point of the toner. Thus, the developer is not subjected to fixing in the contact area Q6.

In the present exemplary embodiment, if the recording sheet S is any of the mending-object media, the thermopressing roller 12 is heated to mend any flaws in the mending-object medium, on which flaws tend to be noticeable.

In the present exemplary embodiment, if the recording sheet S is none of the mending-object media, the recording sheet S is not heated. That is, any non-mending-object medium, on which flaws are less noticeable, is not subjected to flaw mending.

While the present exemplary embodiment relates to a case where the thermopressing roller 12 is not heated if the recording sheet S is none of the mending-object media, the present disclosure is not limited to such an embodiment. The thermopressing roller 12 may be heated for non-mending-object media as well for flaw mending. In such a case, to stably mend the flaws in the mending-object media that are more likely to have flaws, the temperature for heating the mending-object media may be set higher than the temperature for heating the non-mending-object media.

In the present exemplary embodiment, if the recording sheet S is none of the mending-object media, the fan 17 is activated to cool the thermopressing roller 12. Accordingly, the recording sheet S passing through the contact area Q6 is cooled, and the developer on the surface of the recording sheet S is cooled. If the developer melted by passing through the fixing area Q5 and yet to be fully fixed comes into contact with any element of the copying machine U, the developer may be disturbed, resulting in a defective image. In view of such a situation, in the present exemplary embodiment, the recording sheet S is cooled in the contact area Q6 located on the downstream side relative to the fixing area Q5.

In the present exemplary embodiment, if the recording sheet S is any of the mending-object media, the speed of transport is set lower than for the media other than the mending-object media. Correspondingly, the time period for mending the flaws in the medium in the contact area Q6 is increased.

In the present exemplary embodiment, if the recording sheet S is any of the mending-object media, the contact pressure generated in the contact area Q6 is set to a predetermined level; whereas if the recording sheet S is none of the mending-object media, the contact pressure is set to the lowest level required for the transport. Accordingly, any mending-object medium is subjected to flaw mending when passing through the contact area Q6, and any non-mending-object medium is transported with less resistance. Furthermore, the contact pressure is adjusted with reference to the thickness of the recording sheet S.

### Modifications

While an exemplary embodiment of the present disclosure has been described in detail above, the present disclosure is not limited to the above exemplary embodiment. Various changes may be made to the above exemplary embodiment within the scope of the present disclosure defined by the appended claims. Modifications (H01) to (H09) of the present disclosure are as follows.

(H01) While the above exemplary embodiment relates to the copying machine U serving as an exemplary image forming apparatus, the image forming apparatus is not limited thereto and may be, for example, a facsimile, a printer, or a multifunction machine.

(H02) While the above exemplary embodiment relates to an image forming apparatus to be used with developers having four respective colors, the image forming apparatus is not limited thereto and may be, for example, a monochrome image forming apparatus or any other multicolor image forming apparatus to be used with developers having three or less colors or five or more colors.

(H03) While the above exemplary embodiment relates to an application of the present disclosure to an image forming apparatus employing an electrophotographic scheme, the present disclosure may be applied to an image forming apparatus employing any other scheme. For example, the medium mending device 11 according to the present disclosure may be applied to an inkjet image forming apparatus and be provided on the downstream side relative to an image drawing head, so that any flaws in a medium are to be mended. If a heating roll configured to dry ink is provided on the downstream side relative to the head, the medium mending device 11 may be provided on the downstream side relative to the heating roll.

(H04) While the above exemplary embodiment relates to a case where whether to mend flaws by heating the thermopressing roller 12 or increasing the contact pressure from the pressurizing roller 13 is determined automatically with reference to the type of the medium, the determination scheme is not limited thereto. For example, whether to mend flaws may be determined manually by the user.

(H05) While the above exemplary embodiment relates to a case where any medium other than the mending-object media is not subjected to flaw mending, the flaw mending scheme is not limited thereto. Flaw mending may be performed regardless of the type of the medium.

(H06) While the above exemplary embodiment relates to a case where any of the mending-object media is transported at a low speed, the speed of transport is not limited thereto. The speed of transport may be the same between the mending-object media and the non-mending-object media.

(H07) While the above exemplary embodiment relates to a case where the contact pressure generated in the contact area Q6 is adjusted with reference to the thickness of the medium, the contact pressure is not limited thereto. The contact pressure may be uniform, regardless of the thickness of the medium.

(H08) The values, materials, and other relevant factors specified in the above exemplary embodiment are not limited to those given above and may be changed according to need in conformity with relevant design, specifications, and so forth.

(H09) While the above exemplary embodiment relates to a case where the fixing device F and the medium mending device 11 include the heating roller Fh and the thermopressing roller 12 that are in the form of rolls, the fixing device F and the medium mending device 11 are not limited thereto. The configuration of the fixing device F and the medium mending device 11 may each be changed in any way; for example, a configuration including a plurality of rolls and a belt, a so-called heating belt, stretched over the rolls may be employed. Likewise, the pressing roller Fp and the pressurizing roller 13 may each be changed to a configuration including a belt.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A medium mending device comprising:
a heating component configured to heat a medium having an image recorded; and
a pressing component positioned against the heating component and configured to press the medium that is to be nipped between the pressing component and the heating component, the pressing component pressing the medium with such a pressure as to squash any flaws in the medium.
   (((2)))

The medium mending device according to (((1))),
wherein the heating component faces a side of the medium, the side having the recorded image.
   (((3)))

The medium mending device according to (((1))) or (((2))),
wherein the pressing component and the heating component are located on a downstream side relative to a fixing component in a direction of transport of the medium, the fixing component being configured to fix an unfixed image formed of developer.
   (((4)))

The medium mending device according to (((3))),
wherein a temperature at which the heating component heats the medium is lower than a melting point of the developer.

(((5)))

The medium mending device according to any one of (((1))) to (((3))), further comprising:
a cooling component configured to cool the heating component, the cooling component cooling the heating component if the medium is other than a predetermined mending-object medium.
   (((6)))

The medium mending device according to (((5))),
wherein the heating component has a hollow cylindrical shape,
wherein the heating component is provided with a heat source extending through an inside of the heating component, the heat source heating the heating component when the heat source is energized, and
wherein the cooling component is located at an end of the heating component.

(((7)))

The medium mending device according to (((1))) or (((2))),
wherein the heating component is configured to heat a medium having an image recorded with ink ejected to the medium, the heating component drying the ink by heating the ink.
   (((8)))

The medium mending device according to any one of (((1))) to (((7))),
wherein the heating component heats the medium if the medium is a predetermined mending-object medium.
   (((9)))

The medium mending device according to any one of (((1))) to (((8))),
wherein if the medium is the predetermined mending-object medium, a temperature at which the heating component heats the medium is higher than a temperature at which the heating component heats a medium other than the predetermined mending-object medium.
   (((10)))

The medium mending device according to any one of (((1))) to (((9))),
wherein if the medium is other than the predetermined mending-object medium, the heating component refrains from heating the medium.
   (((11)))

The medium mending device according to any one of (((7))) to (((10))), further comprising:
a cooling component configured to cool the heating component, the cooling component cooling the heating component if the medium is other than a predetermined mending-object medium.
   (((12)))

The medium mending device according to any one of (((1))) to (((11))),
wherein if the medium is the predetermined mending-object medium, the heating component transports the medium at a speed lower than a speed at which the heating component transports a medium other than the mending-object medium.
   (((13)))

The medium mending device according to any one of (((1))) to (((12))), further comprising:
a pressure adjusting component configured to adjust the pressure from the pressing component with reference to a type of the medium and such that the pressure to be applied to the medium falls within a predetermined range.
   (((14)))

The medium mending device according to (((13))),
wherein the pressure adjusting component reduces the pressure from the pressing component with an increase in a thickness of the medium.
   (((15)))

The medium mending device according to (((13))) or (((14))),
wherein if the medium is other than the predetermined mending-object medium, the pressure adjusting component sets the pressure from the pressing component to a lowest level required for transport of the medium.
   (((16)))

A medium mending device comprising:
a pressing component configured to come into contact with a medium over an entirety of the medium in a width direction of the medium and to apply such a pressure as to squash any flaws in the medium.
   (((17)))

An image forming apparatus comprising:
an image recording component configured to record an image on a medium; and
the medium mending device according to any one of (((1))) to (((16))) that is configured to mend any flaws in the medium having an image recorded.

What is claimed is:

1. A medium mending device comprising:
a heating component configured to heat a medium having an image recorded; and
a pressing component positioned against the heating component and configured to press the medium that is to be nipped between the pressing component and the heating component, the pressing component pressing the medium with such a pressure as to squash any flaws in the medium.

2. The medium mending device according to claim 1,
wherein the heating component faces a side of the medium, the side having the recorded image.

3. The medium mending device according to claim 1,
wherein the pressing component and the heating component are located on a downstream side relative to a fixing component in a direction of transport of the medium, the fixing component being configured to fix an unfixed image formed of developer.

4. The medium mending device according to claim 3,
wherein a temperature at which the heating component heats the medium is lower than a melting point of the developer.

5. The medium mending device according to claim 3, further comprising:
a cooling component configured to cool the heating component, the cooling component cooling the heating component if the medium is other than a predetermined mending-object medium.

6. The medium mending device according to claim 5,
wherein the heating component has a hollow cylindrical shape,
wherein the heating component is provided with a heat source extending through an inside of the heating component, the heat source heating the heating component when the heat source is energized, and
wherein the cooling component is located at an end of the heating component.

7. The medium mending device according to claim 1,
wherein the heating component is configured to heat a medium having an image recorded with ink ejected to the medium, the heating component drying the ink by heating the ink.

8. The medium mending device according to claim 1,
wherein the heating component heats the medium if the medium is a predetermined mending-object medium.

9. The medium mending device according to claim 8,
wherein if the medium is the predetermined mending-object medium, a temperature at which the heating component heats the medium is higher than a temperature at which the heating component heats a medium other than the predetermined mending-object medium.

10. The medium mending device according to claim 8,
wherein if the medium is other than the predetermined mending-object medium, the heating component refrains from heating the medium.

11. The medium mending device according to claim 10, further comprising:
a cooling component configured to cool the heating component, the cooling component cooling the heating component if the medium is other than a predetermined mending-object medium.

12. The medium mending device according to claim 8,
wherein if the medium is the predetermined mending-object medium, the heating component transports the medium at a speed lower than a speed at which the heating component transports a medium other than the mending-object medium.

13. The medium mending device according to claim 1, further comprising:
a pressure adjusting component configured to adjust the pressure from the pressing component with reference to a type of the medium and such that the pressure to be applied to the medium falls within a predetermined range.

14. The medium mending device according to claim 13,
wherein the pressure adjusting component reduces the pressure from the pressing component with an increase in a thickness of the medium.

15. The medium mending device according to claim 13,
wherein if the medium is other than the predetermined mending-object medium, the pressure adjusting component sets the pressure from the pressing component to a lowest level required for transport of the medium.

16. A medium mending device comprising:
a pressing component configured to come into contact with a medium over an entirety of the medium in a width direction of the medium and to apply such a pressure as to squash any flaws in the medium.

17. An image forming apparatus comprising:
an image recording component configured to record an image on a medium; and
the medium mending device according to claim 1 that is configured to mend any flaws in the medium having an image recorded.

18. An image forming apparatus comprising:
an image recording component configured to record an image on a medium; and
the medium mending device according to claim 2 that is configured to mend any flaws in the medium having an image recorded.

19. An image forming apparatus comprising:
an image recording component configured to record an image on a medium; and
the medium mending device according to claim 3 that is configured to mend any flaws in the medium having an image recorded.

20. An image forming apparatus comprising:
an image recording component configured to record an image on a medium; and
the medium mending device according to claim 4 that is configured to mend any flaws in the medium having an image recorded.
